(19) United States
(12) Patent Application Publication
(10) Pub. No.: US 2025/0002303 A1
(43) Pub. Date: Jan. 2, 2025

(54) MOVEMENT ASSIST SYSTEM FOR CRANE OPERATIONS AND METHOD OF USING THE SAME

(71) Applicant: Kundel Industries, Inc., Vienna, OH (US)

(72) Inventors: Robert KUNDEL, Sr., Cortland, OH (US); Andrew PIRIGYI, Warren, OH (US)

(73) Assignee: Kundel Industries, Inc., Vienna, OH (US)

(21) Appl. No.: 18/663,190

(22) Filed: May 14, 2024

Related U.S. Application Data
(60) Provisional application No. 63/510,388, filed on Jun. 27, 2023.

(51) Int. Cl. B66C 15/00; B66C 19/00

(52) U.S. Cl. CPC B66C 15/00; B66C 19/00; B66C 2700/08

(57) ABSTRACT

An overhead crane assembly having a movement assist system. The assembly includes a bridge engaged with end trucks movable along runway beams. A hoist assembly is engaged with a trolley that is movable along the bridge. The load is suspended from the hoist assembly via a hoist rope which has an inclinometer engaged therewith. A processor is coupled with the inclinometer and motors in the trolley and end trucks. Programming in the processor is configured to activate and deactivate the motors in response to signals from the inclinometer. The movement assist system is actuated by a human operator applying a physical force to the load by pushing or pulling the same. When this occurs, the inclinometer determines the hoist rope is at an angle relative to Normal and signals the processor which, in turn, activates the motor(s) and assists the operator in moving the load.

### REFERENCE TO RELATED APPLICATIONS

This application claims the benefit of U.S. Provisional Patent Application Ser. No. 63/510,388, filed Jun. 27, 2023, the entire disclosure of which is incorporated herein by reference.

### TECHNICAL FIELD

This disclosure is directed to crane operations and, more particularly, to a movement assist system for use with a crane. The crane includes a translation assembly movable relative to at least one support beam and a hoist assembly coupled to the translation assembly and from which a load is suspended via a hoist rope. The translation assembly includes motorized trolleys and end trucks running inside runway beams, with the motorization being controlled via operator input and sensor feedback. In particular, a sensor, such as one the form of an inclinometer, monitors the position/orientation of the hoist rope relative to Normal and transmits signals to a processor programmed to operate the translation assembly. When the human operator applies a physical force to the load by pushing or pulling the same, the inclinometer determines that the hoist rope is oriented at an angle relative to Normal. The inclinometer signals the information to the processor, the processor actuates the translation assembly, and the load is moved. When the physical force ceases, the inclinometer signals to the processor that the hoist rope is once again aligned with Normal, the processor shuts down the translation assembly, and movement of the load thereby ceases.

### BACKGROUND ART

Many manufacturing facilities and other industries utilize cranes to help move heavy loads between locations at the facility. One type of crane commonly utilized for this purpose is known as an overhead bridge crane. Overhead bridge cranes comprise a pair of parallel, longitudinally-extending runway beams that are spaced a distance laterally apart from one another. An end truck is engaged with each runway beam and is movable back and forth therealong via a plurality of wheels which engage the beam. A bridge extends laterally between the two runway beams and is operatively engaged with the two end trucks. When the end trucks are actuated, the movement of the end trucks along the runway beams causes the bridge to travel longitudinally relative to the beams. A trolley is engaged with the bridge and is movable therealong in a direction orthogonal to the runway beams via a plurality of wheels that engage the bridge. A hoist mechanism is operatively engaged with and moves with the trolley. When it is necessary to move a load using the crane, a rigger will secure the load to the hoist mechanism and a crane operator will then use the hoist mechanism to lift the load off the floor or work surface. The load is then suspended from the bridge via the trolley and hoist mechanism and is ready to be moved by the crane.

In many overhead bridge cranes, the end trucks and trolley are motorized and the crane operator will stand a distance away from the load and use a pendulum controller hanging from the crane to activate and deactivate the end trucks and trolley. When the end trucks are actuated, the bridge and thereby the hoist mechanism and load will move longitudinally relative to the runway beams. When the trolley is actuated, the hoist mechanism and thereby the load will move laterally relative to the runway beams. By selectively activating and deactivating the end trucks and trolley, the operator can move the suspended load to the desired location.

In other overhead bridge cranes, the end trucks and trolley are not motorized. Instead, the crane operator will initiate movement of the end trucks and trolley by physically manipulating the load. Once the load is suspended from the crane, the crane operator will physically push or pull the load towards the desired end location. When the operator pushes or pulls the load laterally relative to the runway beams, the applied force is transferred via the load to the hoist mechanism and subsequently to the trolley, thereby causing the trolley to move along the bridge, taking the load with it. When the operator pushes or pulls the load longitudinally relative to the runway beams, the applied force is transferred via the load to the hoist mechanism, then to the trolley, and then to the bridge. Because the force is not applied in a direction which will cause the trolley to move along the bridge, the applied force will, instead, cause the bridge to transfer the force to the end trucks, and the end trucks will move longitudinally along the beams, and thereby carrying the load in the same direction.

The crane operator is therefore able to “steer” the load longitudinally and laterally as need be in order to move the load from the first location to the desired second location. While the crane physically supports the load during these longitudinal and lateral movements, the operator has to expend a decent amount of manual effort and energy to get the load and thereby components of the crane to move to the desired location.

### SUMMARY OF THE INVENTION

The present disclosure is directed to a crane assembly in which there is a movement assist system which aids a crane operator who needs to physically manipulate a load in order to effect motion in components of the crane. A method of moving a load with an overhead crane assembly having a movement assist system. The assembly includes a bridge operably engaged with a runway beam via an end truck, where the end truck is movable along the runway beam. A hoist assembly is engaged with a trolley which is movable along the bridge. The load is suspended from the hoist assembly via a hitch rope having an inclinometer engaged therewith. A processor is coupled with the inclinometer and motors in end truck and trolley. The processor includes programming for activating and deactivating the motors in response to signals from the inclinometer and other sensors. The movement assist system is actuated by a human operator applying a physical force to the load by pushing or pulling the load. When this occurs, the inclinometer signals the processor which activates the motor(s) and aids the operator in moving the load. When the operator ceases to apply force to the load, the signal from the inclinometer ceases and the processor automatically deactivates the motor(s).

In one aspect, an exemplary embodiment of the present disclosure may provide an overhead crane assembly for moving a load comprising at least one support beam; a translation assembly moveable relative to the at least one support beam; a hoist assembly operatively engaged with the translation assembly, wherein the hoist assembly is adapted to suspend a load therefrom; and a movement assist system operably engaged with the translation assembly and the hoist assembly; wherein the movement assist system is operable to initiate movement of the translation assembly upon application of a physical force to the load by a human operator.

In one embodiment, the hoist assembly may include a hoist rope or chain adapted to be engaged with the load; and wherein the movement assist system includes an inclinometer engaged with the hoist rope or chain. In one embodiment, the movement assist system further includes a processor provided with programming configured to control the movement of the translation assembly. In one embodiment, the processor is configured to receive signals from the inclinometer. In one embodiment, actuation of the translation assembly is initiated by the processor when a signal from the inclinometer indicates that the hoist rope is oriented at an angle relative to Normal.

In one embodiment, the at least one support beam comprises at one runway beam extending in a longitudinal direction; and wherein the translation assembly includes an end truck moveable longitudinally along the at least one runway beam, and the end truck is motorized. In one embodiment, the at least one support beam further comprises a bridge oriented transverse to the at least one runway beam, and wherein the bridge is engaged with the end truck. In one embodiment, the translation assembly further comprises a trolley movable along the bridge. In one embodiment, the hoist assembly is operably engaged with the bridge via the trolley. In one embodiment, the trolley includes a motor which is actuated to move the trolley along the bridge only after the human operator applies a pushing or pulling physical force to the load suspended from the hoist assembly.

In another aspect, an exemplary embodiment of the present disclosure may provide a movement assist system for an overhead crane assembly comprising an inclinometer engaged with a hoist rope extending between a hoist assembly of the overhead crane assembly and a load to be moved; a motor provided on a translation assembly of the overhead crane assembly; a processor operably engaged with the inclinometer and the motor; wherein the processor is configured to receive signals from the inclinometer; and wherein the processor is configured to actuate the motor upon receipt of a first signal from the inclinometer indicating that the hoist rope is oriented at an angle relative to Normal. In one embodiment, the processor is configured to shut off the motor upon receipt of a second signal from the inclinometer indicating that the hoist rope is aligned with Normal.

In another aspect, and exemplary embodiment of the present disclosure may provide a method of moving a load with an overhead crane assembly comprising operatively engaging a translation assembly with at least one support beam; operatively engaging a hoist assembly with the translation assembly; operatively engaging a movement assist system with the hoist assembly; suspending a load from the hoist assembly; applying a physical force to the load via a hand of a human operator; actuating the movement assist system upon application of the physical force; actuating the translation assembly through actuating of the movement assist system; and moving the load relative to the at least one support beam via the translation assembly.

In one embodiment, applying the physical force to the load comprises one of pushing and pulling the load with the hand of the human operator. In one embodiment, actuating the movement assist system comprises moving a hoist rope of the hoist assembly from being aligned with Normal to being oriented at an angle to Normal. In one embodiment, actuating the translation assembly includes starting a motor provided on the translation assembly. In one embodiment, the method further comprises engaging an inclinometer with a hoist rope extending between the hoist assembly and the load; and measuring an angle of the hoist rope relative to Normal with the inclinometer. In one embodiment, the method further comprises deactivating the movement assist system by halting the application of physical force to the load with the hand of the human operator. In one embodiment, the method further comprises halting movement of the translation assembly by shutting off a motor provided on the translation assembly when the application of physical force to the load is halted.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a top, front, left side perspective view of an overhead bridge crane assembly incorporating the movement assist system of the present disclosure;

FIG. 2 is a top, front, left side perspective view of a first end truck of the overhead bridge crane assembly;

FIG. 3 is a partial left side elevation view of the overhead bridge crane assembly and movement assist system of FIG. 1 shown supporting a load in an at-rest or first position relative to one of the runway beams;

FIG. 3A is a partial top plan view of the bridge of the overhead bridge crane assembly showing the trolley which is selectively movable therealong;

FIG. 4 is a top, front, right side perspective view of the hoist mechanism of the overhead bridge crane assembly;

FIG. 5 is a partial left side elevation view of the overhead bridge crane assembly and movement assist system showing an operator pushing the load in a first longitudinal direction in order to actuate the movement assist system.

FIG. 6 is a top plan view of part of FIG. 5, showing the operator pushing the load in the first longitudinal direction;

FIG. 7 is a diagrammatic top plan view of the hoist rope showing the possible positioning of two inclinometers for determining the angle of the hoist rope when the load is moved longitudinally and when the hoist rope is moved laterally;

FIG. 8 is a partial left side elevation view of the overhead bridge crane assembly and movement assist system showing the load moved to a second position;

FIG. 9 is a partial top plan view of part of the overhead bridge crane assembly and movement assist system, showing a sample of some of the various directions in which the load may be pushed in order to actuate the movement assist system; and

FIG. 10 is a partial front elevation view of the first end truck, the first runway beam, and the hoist mechanism showing possible movement of the load from Normal.

Similar numbers refer to similar parts throughout the drawings.

### DETAILED DESCRIPTION

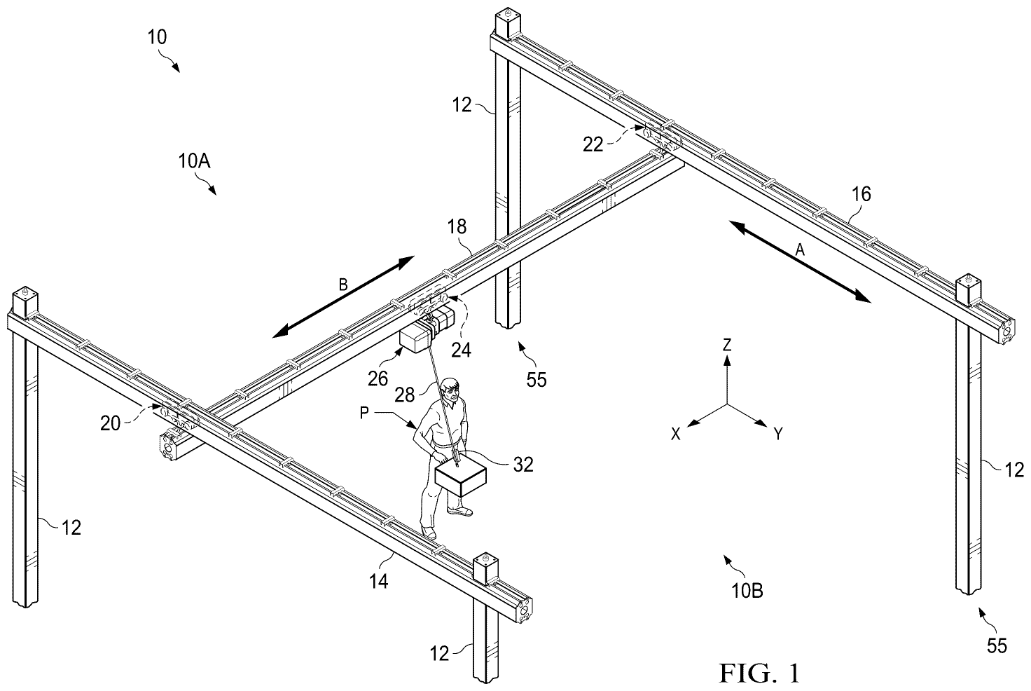

FIG. 1 shows an exemplary overhead bridge crane assembly in accordance with the present disclosure, generally indicated at 10. Crane assembly 10 is illustrated as including at least one support beam, a translation assembly that is movable along the at least one support beam, a hoist assembly operatively engaged with the translation assembly, wherein the hoist assembly is configured to support a load.

Crane assembly 10 includes a plurality of support posts 12 which retain the at least one support beam a distance away from a ground surface. The at least one support beam includes a first runway beam 14, a second runway beam 16, and a bridge 18. Each post 12 is anchored to a support surface “SS” and extends vertically upwardly therefrom. First runway beam 14 and second runway beam 16 are arranged to extend longitudinally and parallel to one another, being spaced a lateral distance apart. Posts 12 are arranged at regularly-spaced intervals and secure runway beams 14, 16 a distance vertically above the support surface “SS”. FIG. 1 shows the runway beams 14, 16 are oriented in a longitudinal direction, indicated by “Y”, and that bridge 18 is oriented in a lateral or transverse direction, indicated by “X”. The vertical posts 12 extend in the direction “Z”.

It should be noted that in other overhead bridge cranes, the posts 12 may be omitted and the first runway beam 14 and second runway beam 16 will be suspended from a ceiling or roof of facility. In yet other overhead cranes, the posts are not permanently anchored to the support surface “SS” but may form part of a movable assembly. The principles of the present disclosure may be applied to any type of overhead crane and should not be narrowly limited to the version illustrated in the attached figures.

Although not specifically illustrated herein, each of the first runway beam 14, second runway beam 16, and bridge 18 includes an I-beam (or I-strut) comprising a vertically oriented web with an upper flange at a top end of the web and a lower flange at a bottom end of the web. It will be understood, however, that other configurations of first runway beam 14, second runway beam 16, and bridge 16 can be utilized in crane assembly 10, without departing from the scope of the present disclosure.

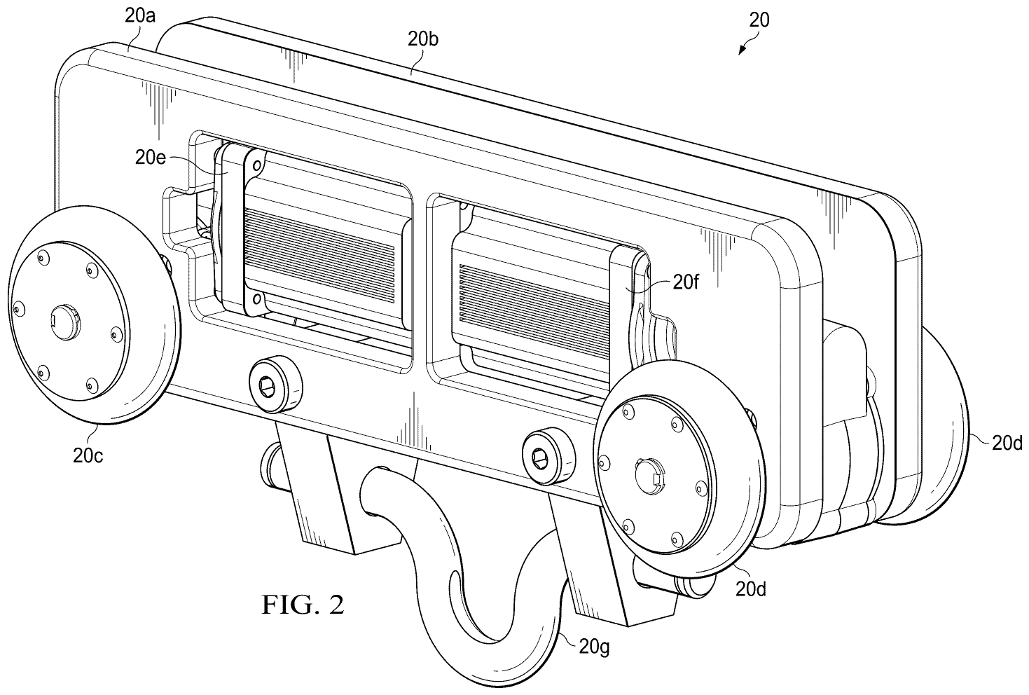

As indicated earlier herein, crane assembly 10 includes a translation assembly which is operable to move along the at least one support beam. In particular, the translation assembly of crane assembly 10 comprises a first end truck 20 which is movable along first runway beam 14 and a second end truck 22 which is movable along second runway beam. FIG. 2 shows an exemplary first end truck 20 which includes a pair of spaced apart plates 20a, 20b upon which are mounted pair of wheels 20c, 20d, and first and second motors 20e, 20f. The first motor 20e is configured to drive the first pair of wheels 20c and the second motor 20f is configured to drive the second pair of wheels 20d. When the wheels 20c, 20d are driven by the first motor 20e to rotate in a first direction, the first end truck 20 moves in a first direction toward first end 10A of crane assembly 10 and away from the second end 10B thereof. When wheels 20c, 22d are driven by the second motor 20f to rotate in the opposite direction, the associated first end truck 20 moves in a second direction, i.e., towards the second end 10B of crane assembly 10. It will be understood that second end truck 22 is substantially identical in structure and function to first end truck 20. FIG. 2 shows that first end truck 22 includes a U-shaped connector 20g which extends downwardly from plates 20a, 20b.

Referring again to FIG. 1, a first end of bridge 18 is operatively engaged with first end truck 20 and thereby with first runway beam 14. A second end of bridge 18 is operatively engaged with second end truck 22 and thereby with second runway beam 16. Bridge 18 extends laterally between first end truck 20 and second end truck 22 and thereby between first runway beam 14 and second runway beam 16. First and second end trucks 20, 22 are configured to translate, i.e., move along the associated first runway beam 14 and second runway beam 16 and, when they do so, bridge 18 is translated, i.e., moved longitudinally relative to first runway beam 14 and second runway beam 16. The longitudinal motion of bridge 18 relative to first and second runway beams 14, 16 is illustrated in FIG. 1 by arrow “A”. As will be understood, the motion may selectively be in a first longitudinal direction moving towards first end 10A of crane assembly 10 or in a second longitudinal direction moving away from second end 10B of crane assembly 10.

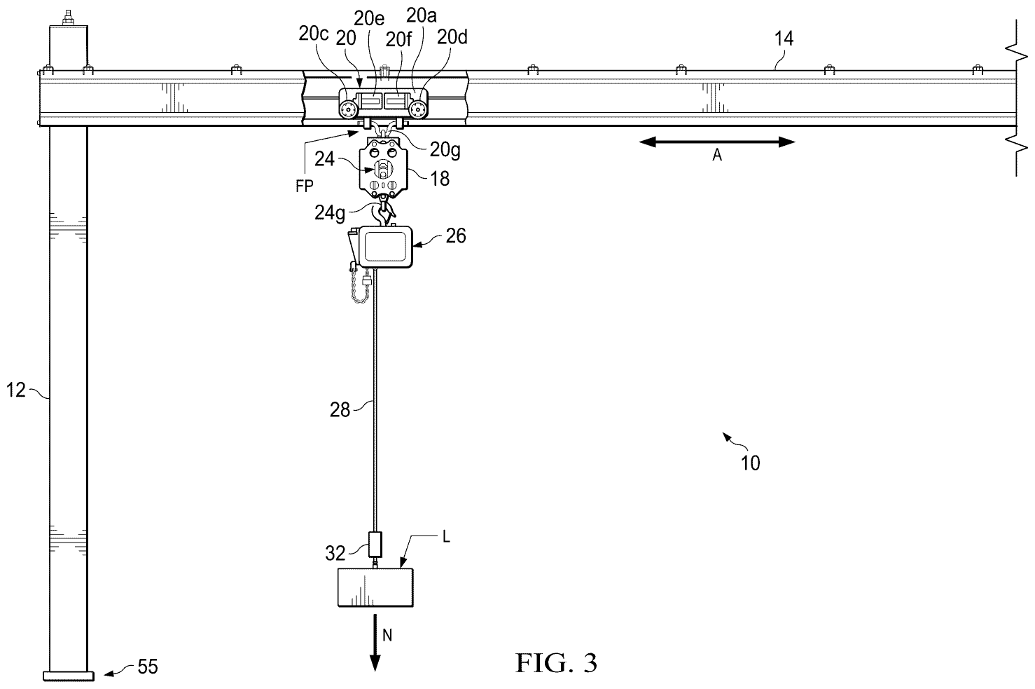

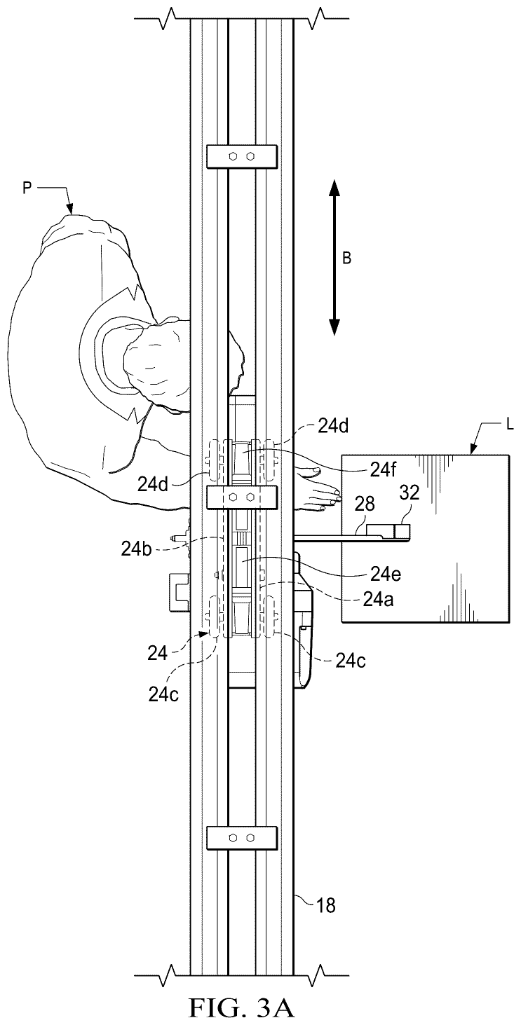

FIGS. 3 and 3A show that the translation assembly of crane assembly 10 further comprises a trolley 24 which is operatively engaged with bridge 18. The figures also show a break-away region of the first runway beam 14 and the first end truck 20 positioned for movement along first runway beam 14. Trolley 24 is substantially identical to first end truck 20 shown in FIG. 2. As best seen in FIG. 3A, trolley 24 includes a pair of spaced-apart plates 24a, 24b, a plurality of sets of wheels 24c, 24d, motors 24e, 24f, and a U-shaped connector 24g (FIG. 3). When first motor 24e is activated, the motor drives the wheels 24c in a direction towards first runway beam 14. When second motor 24f is activated, the wheels 24d are driven towards second runway beam 16. The lateral movement or translation of trolley 24 along bridge 18 is indicated by arrow “B” in FIGS. 1 and 3.

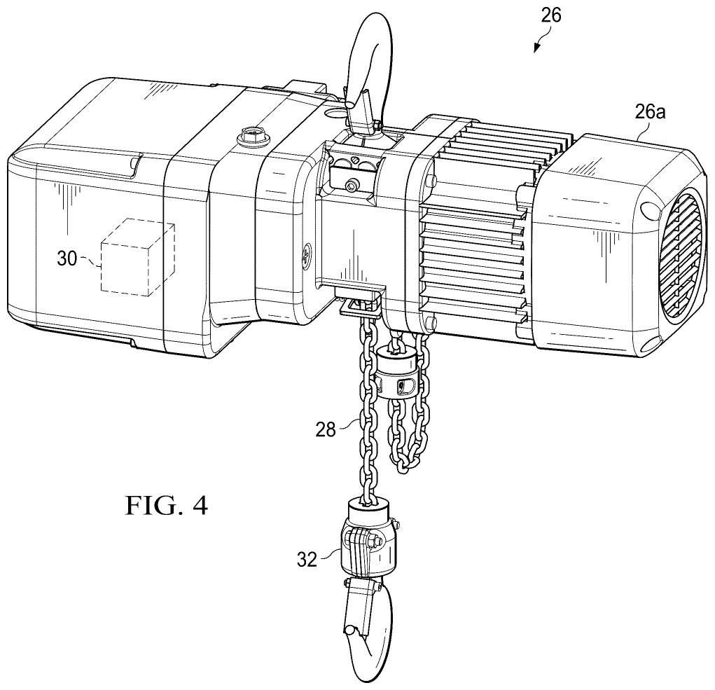

Crane assembly 10 further includes a hoist mechanism 26 (FIG. 4) which is operatively engaged with trolley 24 via the U-shaped connector 24g as will be further described herein. Hoist mechanism 26, when so engaged, is configured to move in unison with trolley 24 as the trolley moves along bridge 18. A hoist rope 28 hangs downwardly from hoist mechanism 26 and is configured to be rigged to a load “L” that is to be moved by crane assembly 10. The term “hoist rope” should be understood to be representative of any rope, chain, wire, cable or other similar component that is used to secure the load “L” to hoist mechanism 26. Hoist mechanism 26 illustrated in the attached figures is simplified for clarity of illustration.

FIG. 3 shows the load “L” suspended from the bridge 18 of crane assembly 10 via the trolley 24, hoist mechanism 26, and hoist rope 28. Since the load “L” is engaged with the trolley 24, when the trolley 24 moves laterally relative to bridge 18, the hoist mechanism 26 and thereby the load “L” moves laterally relative to bridge 18. When the bridge 18 moves longitudinally relative to the runway beams 14, 16, the hoist mechanism 26 and thereby the load “L” also moves longitudinally relative to the runway beams 14, 16.

As described above, each of the first end truck 20, second end truck 22, and trolley 24 includes two motors, such as motors 20e, 20f of first end truck 20, and motors 24e, 24r of trolley 24. One suitable motor for use in crane assembly 10 is a PARVALUX® motor. (PARVALUX® is a registered trademark of Parvalux Electric Motors of Bournemouth, United Kingdom). Each motor on first end truck 20, second truck 22, and trolley 24 includes a servo controller which is operatively coupled with a processor 30 (FIG. 4) programmed to control the movement assist system of the present disclosure. Suitable servo controllers for use in crane assembly 10 are those sold under the trademark Escon®. (Escon® is a registered trademark of MAXON MOTOR AG of Sachseln SWITZERLAND).

Referring to FIG. 4, an exemplary hoist mechanism 26 is shown in isolation prior to engagement with trolley 24 on bridge 18. Hoist mechanisms are known in the art and so only certain features of hoist mechanism 26 will be discussed hereafter. Hoist mechanism 26 includes a motor 26a which is actuatable to raise or lower the hoist rope or hoist wire 28. A hanger hook 26b is provided on hoist mechanism 26 to secure the same to the U-shaped connector 24g provided on trolley 24. The processor for controlling hoist mechanism 26, trolley 24, first end truck 20, and second end truck 22 may be located anywhere on crane assembly 10. However, by way of example only, processor 30 is illustrated in phantom in FIG. 4 as being located on hoist mechanism 26. Processor 30 is provided with specialized programming to control all electrically-operated components of the movement assist system of the crane assembly 10, as will be discussed later herein. Processor 30 includes specialized programming configured to control the motors of the end trucks 20, 22 and trolley via their servo controllers or via a single servo controller (not shown). The programming in processor 30 controls the activation and deactivation of the various motors and thereby controls the movements of the first end truck 20, second end truck 22, and trolley 24.

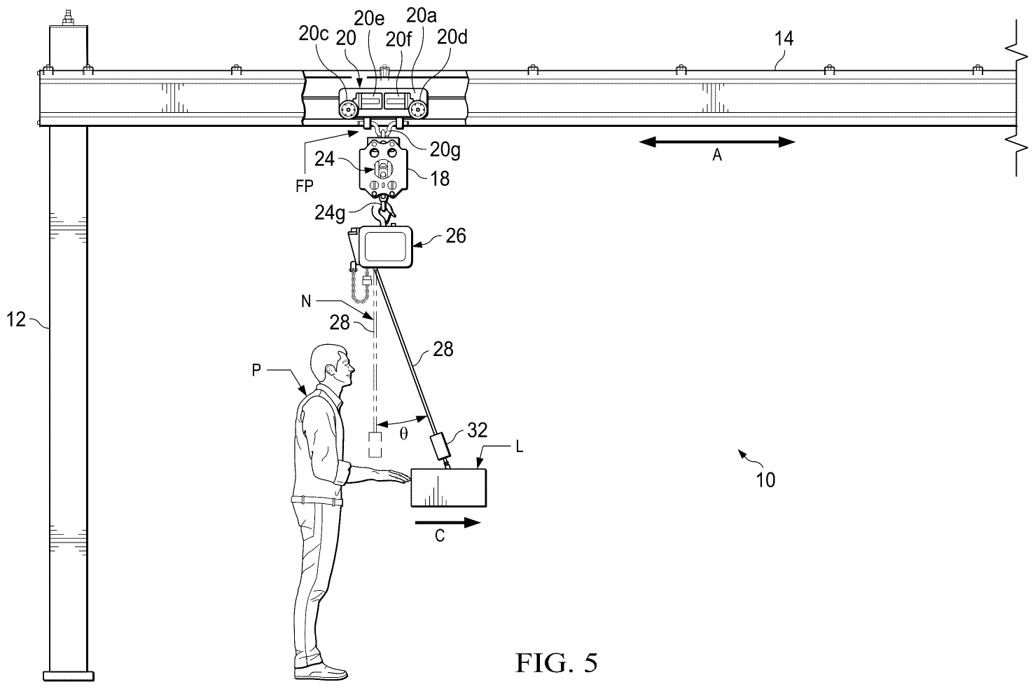

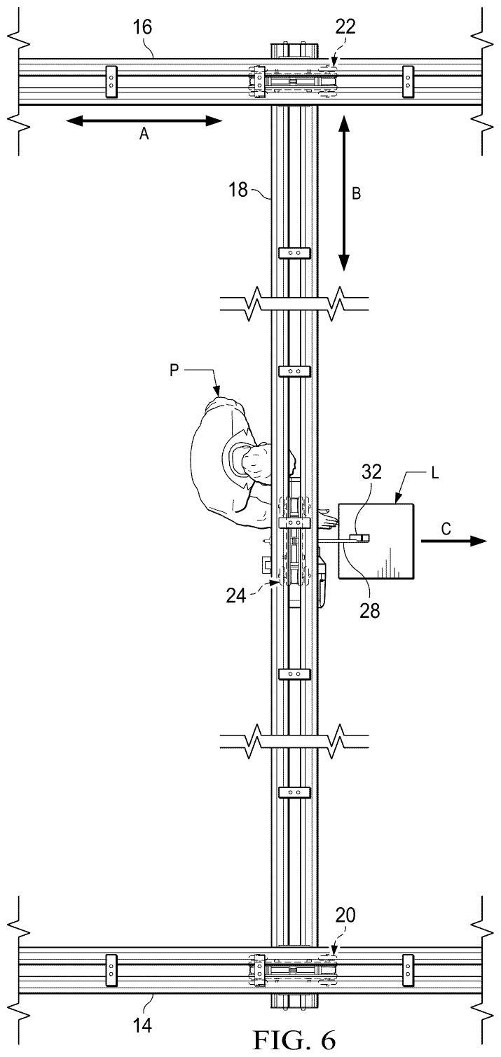

Crane assembly 10 further comprises at least one inclinometer 32 which is operatively engaged with the hoist rope 28 at a location remote from hoist mechanism 26 and proximate load “L”. Inclinometer 32 is a “tilt-sensor” which is utilized to determine the angle of hoist rope 28 relative to normal “N” (FIG. 5), i.e., the “tilt” of the hoist rope 28, as will be explained further herein. In some instances, a single inclinometer 32 will be attached to hoist rope 28 while in other instances, two inclinometers 32a, 32b (FIG. 6) will be utilized. The inclinometer 32 may be a static inclinometer which simply determines the angle of hoist rope 28, particularly at the end of a push on the load “L” applied by the operator “P”. Alternatively, the inclinometer 32 may be a dynamic inclinometer which includes an accelerometer and continuously measures the angle of the hoist rope 28 while the inclinometer 32 is moving through space with the hoist rope 28 and load “L”.

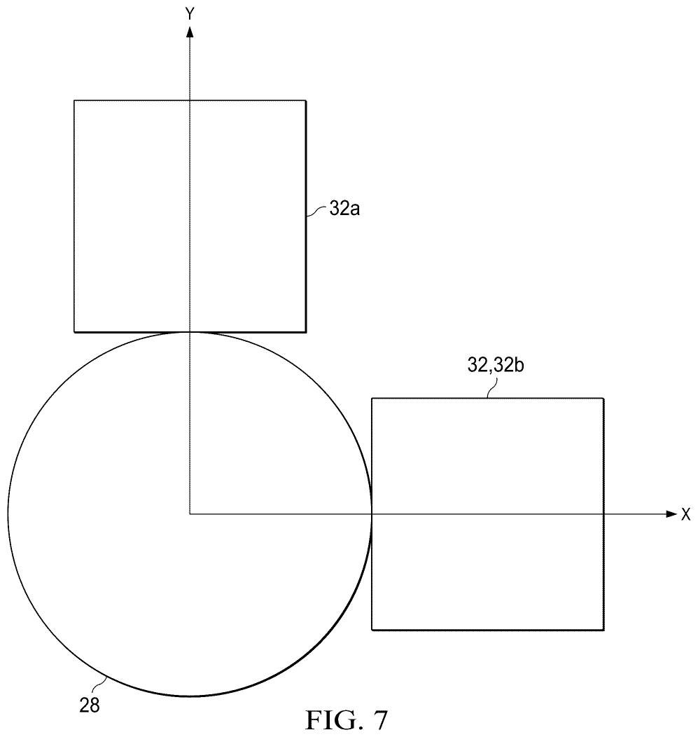

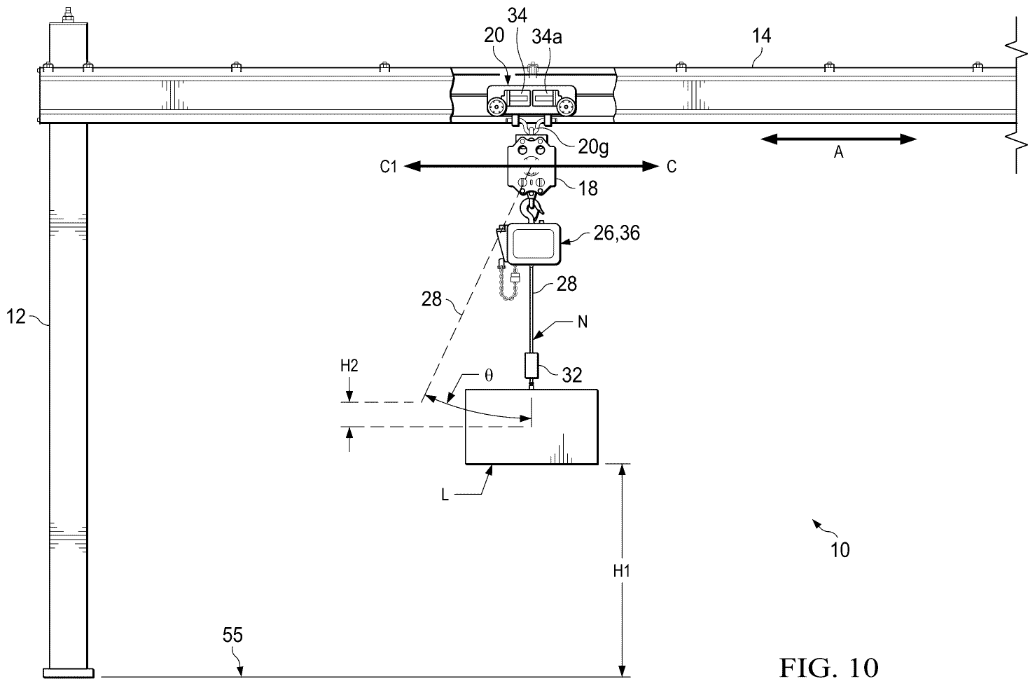

One determining factor in deciding whether one or two inclinometers should be utilized is the nature of the hoist rope 28 provided on hoist mechanism 26. FIG. 5 shows a single inclinometer 32 in use while FIG. 6 is a diagrammatic view of the hoist rope 28 with two inclinometers 32a, 32b attached thereto. If the hoist rope 28 is of a type that cannot rotate or turn, then at least two inclinometers will need to be engaged with hoist rope 28 in order to measure the angle of the rope from Normal “N” while moving the load “L” along the runway beams 14, 16 or bridge 18, or along both the runway beams 14, 18 and bridge 18 at the same time. As indicated in FIG. 1, bridge 18 runs along the X-axis and first and second runway beams extend parallel to the Y-axis. FIG. 7 shows that a first inclinometer 32a will be mounted to the hoist rope 28 through the Y-axis and the second inclinometer 32b being mounted to the hoist rope 28 through the X-axis. When the load is pushed in the Y-direction, the second inclinometer 32b is calibrated to only measure the angle the load is pushed to about the X-axis and in turn would send a signal via the processor 30 to only actuate the motors in the first end truck 20 and second end truck 22. When the load is pushed in the X-direction, the first inclinometer is calibrated to only measure the angle about the Y-axis and will therefore send a signal to the trolley motors 24e, 24f. Inclinometers can measure positive or negative angles, so the negative X-direction and the negative Y-direction (shown in FIG. 10) will be covered as well by the provision of two inclinometers. Furthermore, if the load “L” is pushed in-between the X-axis and Y-axis, the motors of the trolley 24 and each of the first and second end trucks 20, 22 will be turned on by processor 30.

If, on the other hand, the hoist rope 28 can rotate and turn, then a dynamic inclinometer can be utilized as part of the movement assist system of the present disclosure or a single inclinometer can be used in tandem with an accelerometer (not shown) in order to determine the direction and angle to which the load “L” is being pushed by the operator. The accelerometer may be engaged with the hoist rope 28 in a similar region to the inclinometer 32 and could particularly be positioned in such a way that the reference character 32a or 32b represents an inclinometer while the other of the reference characters 32a or 32b represents the accelerometer. Utilizing an accelerometer attached to the end of the hoist rope 28 to send a direction signal to the processor may also be used to ensure the motors on the first and second end trucks 20, 22 and/or the motor on the trolley 24 do not kick on from the load swinging when the operator releases the load from the hitch mechanism 26. Additionally or alternatively, an accelerometer could be attached to the trolley 24 and each of the first and second end trucks 20, 22 to signal the associated motors to shut off when the end of the runway 14, 16 or bridge 18 is impacted by one of the end trucks or the trolley, respectively.

Crane assembly 10 may further includes one or more sensors, such as optical sensors to provide additional data to processor 30 that can be used to better control the operation of crane assembly 10. These additional sensors can be provided at any suitable locations on crane assembly 10 such as at the ends of the first and second runway beams 14, 16 or additional sensors may be provided in the environment of the crane assembly 10.

The movement assist system in accordance with the present disclosure comprises first end truck 20, second end truck 22, trolley 24, processor 30, and inclinometer 32. In some embodiments, the movement assist system further comprises an accelerometer (either as a separate component or and part of a dynamic inclinometer 32). In yet other embodiments, the movement assist system may further comprise one more sensors which provide information utilized by the programming of processor 30 to determine that the load “L” has been moved away from the first position “FP” and to what extent this has occurred, i.e., where is the load “L” now located in space. When the programming of processor 30 has determined the load “L” has been moved using data from at least the inclinometer 32, the processor 30 actuates one or more of the motors of first end truck 20, second end truck 22, and trolley 34 based on the processor's determination. The movement assist system is activated by the application of force to the load “L” from the operator. The degree of lateral movement of the trolley 24 along bridge 18 and the degree of longitudinal movement of the bridge 18 relative to the runway beams 14, 16, is based on the size of the pushing or pulling force applied to the load “L” by the operator's hand. The movement assist system may additionally include limit switches which are operatively coupled to the motors of one of first end truck 20, second end truck 22, or trolley 26. When the movement bridge 18 or trolley 24 contacts the limit switch the motor(s) will be automatically shut off and movement of the bridge or trolley substantially immediately ceases.

With reference to FIGS. 1-8, crane assembly 10 and the movement assist system provided thereon is used in the following manner to move a load “L” from one location to another. FIG. 3 shows load “L” in an initial or first position “FP”. In this first position “FP”, the load “L” is suspended from hoist mechanism 26 via hoist rope 28. The hoist rope 28 is oriented Normal “N” to the bridge 18 (not shown in this figure) and thereby to first runway beam 14. The first position “FP” is an “at rest” rest position, i.e., the load “L” is static or stationary in space, i.e., it is not moving relative to first runway beam 14, second runway beam 16, or bridge 18.

FIG. 5 shows an operator “P” contacting the load “L” with their hand, applying a force to the load “L” and thereby pushing the load “L” in a direction indicated by arrow “C”. The direction of movement “C” is illustrated in FIG. 3A as being parallel to first runway beam 14 and second runway beam 16, and thereby to the longitudinal axis “Y” of crane assembly 10. FIG. 5 shows Normal “N”, in phantom, and further shows the orientation of the hoist rope 28 relative to Normal after the operator “P” has pushed the load “L” in direction “C”. Hoist rope 28 has traveled through an angle Θ from Normal “N” to the position shown in FIG. 3. The angle Θ is measured by inclinometer 32 which sends a signal with that data to processor 30 on hoist mechanism (FIG. 4). The processor 30 uses that information to calculate what direction the load “L” was pushed in and to what extent based upon the angle Θ. It should be noted that while the load “L” is actively being pushed by the operator “P”, inclinometer 32 preferably continuously measures the angle Θ and continuously and wirelessly transmits signals to the processor in which the measured angle data is provided to processor 30.

The programming of processor 30 utilizes the transmitted data to calculate when and for how long to actuate the motor(s) of at least one of the first end truck 20, second end truck 22, or trolley 24. As discussed earlier herein with respect to inclinometer 32, when the load is pushed in the Y-direction, the inclinometer 32 is calibrated to only measure the angle to which the load is pushed about the X-axis. Consequently, the inclinometer 32 will send a first signal to the processor 30 which in turn will send a second signal to the motors in the first end truck 20 and second end truck 22 and will actuate the same. When the operator “P” pushes the load “L” in the X-direction, the inclinometer 32 is calibrated to only measure the angle about the Y-axis and will therefore send a first signal to the processor 30 which, in turn, will send a second signal to the trolley motors 24e, 24f and will actuate the same. In particular, when the operator “P” pushes the load “L”, based on the calculations performed by processor 30, processor 30 sends a signal to the relevant servo controller(s) to actuate the associated motor(s). Actuation of the motor(s), in turn, drives rotation of the wheels 20a, 22a of the respective one or more of first end truck 20, second end truck 22, and trolley 24. Movement of first end truck 20 and second end truck 22 along first runway beam 14 and second runway beam 16, respectively, causes bridge 18 to travel longitudinally relative to runway beams 14, 16 . . . . When the first end truck 20 and second end truck 22 travel along the first runway beam 14 and second runway beam 16, the bridge 18 and thereby the suspended load “L” are moved in the direction “C”.

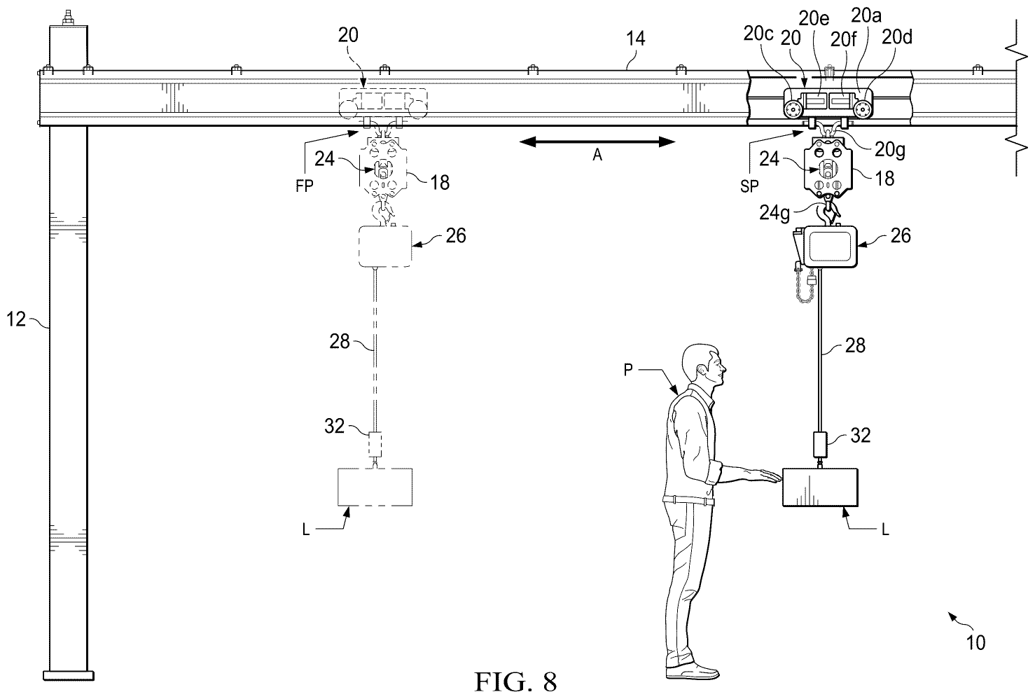

When the operator “P” stops pushing the load “L” in the direction “C”, the angle Θ of hoist rope 28 immediately drops to “zero”. In other words, the hoist rope 28 is once again Normal “N” relative to hoist mechanism 26. When the angle Θ drops to “zero” that information is sent, via inclinometer 32, to processor 30 which, in turn, sends a signal to the servo controller(s) s to deactivate (i.e., switch off) the respective one or more of the motors of first and second end truck 20, 22 and/or trolley 24. Alternatively, the signal to actuate the motors simply ceases. The wheels 20a, 22a will therefore stop rotating as they are no longer driven by the motor(s) and travel along the first runway beam 14 and second runway beam 16 will stop at a new location on the first runway beam 14 and second runway beam 16. Because the first end truck 20 and second end truck 22 have stopped moving along the runway beams 14, 16, the bridge 18, the suspended load “L” will stop moving in the direction “C”. The second position “SP” of the bridge 18 and the suspended load “L” is shown in FIG. 8. As is evident from the figure, the second position “SP” is longitudinally spaced from the first position “FP” shown in phantom on the same figure.

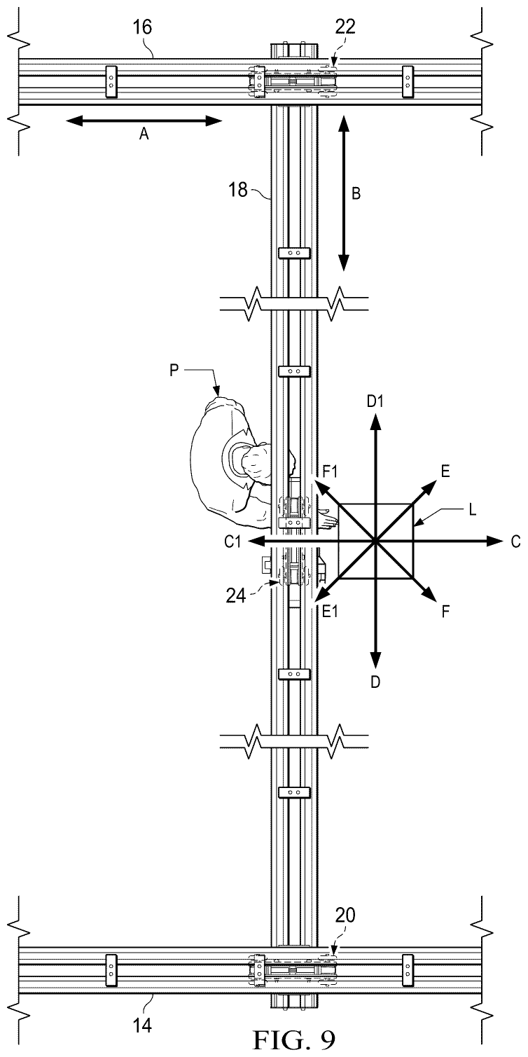

FIG. 9 shows a small sample of various directions in which the operator “P” is able to apply force to the load “L” in order to actuate the movement assist system. The movement of the load “L” in any selected direction is caused by the operator physically pushing or pulling the load “L” in the desired direction to the point that the motors of one or more of first end truck 20, second end truck 22, and trolley 24 kick in. The programming in processor 30 determines which motors to switch on based on the application of force to the load “L” by the operator and to switch those motors off when the application of force to the load by the operator ceases. FIG. 9 shows that the operator applies a force in the direction “C” to move the load “L” longitudinally towards the second end of crane assembly 10, indicated as second end 10B in FIG. 1. FIG. 9 shows the operator may apply a force in the direction “C1” to move the load “L” longitudinally towards the first end of the crane assembly 10, indicated as end 10A in FIG. 1. FIG. 9 further shows the operator may apply a force in the direction “D” to move the load laterally towards first runway beam 14, or in the direction “D1” to move the load laterally towards second runway beam 16. The operator may apply a force in the direction “E” (FIG. 9) to move the load laterally towards second runway beam 16 and simultaneously longitudinally towards second end 10B of crane assembly. Alternatively, the operator may apply a force to the load in the direction “E1” to move the load laterally towards first runway beam 14 and simultaneously longitudinally towards first end 10A of crane assembly 10. The operator may furthermore apply a force in the direction “F” (FIG. 9) to move the load laterally towards first runway beam 14 and simultaneously longitudinally towards second end 10B of crane assembly 10. Alternatively, the operator may apply a force to the load in the direction “F1” to move the load laterally towards second runway beam 16 and simultaneously longitudinally towards first end 10A of crane assembly 10. It will be understood that the directions of force illustrated in FIG. 9 are just a small sample of the possible directions in which the operator may apply force to the load “L”. The programming in processor 30 will adjust the activation and deactivation of the various motors based on the degree of force applied by the operator to move the load laterally towards the first runway beam 14 or second runway beam 16 and the longitudinal movement towards the first end 10A and second end 10B.

FIG. 10 shows that the load “L” being moved along the first and second runway beams 14, 16 towards the first end 10A (FIG. 1) of the crane assembly 10 in the direction “C1”. When the load “L” is pushed or pulled to a positive value, i.e., moved to the left of vertical (as indicated by the arrow “C1” in FIG. 10), the load moves in a positive direction, i.e., in the direction “C1”. Acceleration and velocity of the load are a function of the mass of the load and the angle Θ of the hoist rope 28. As the operator applies force to the load “L”, the angle Θ increases to the point at which the load “L” will move. The motors of at least one of the first end truck 20 and second end truck 22 24 kick in before the point where the load “L” would have started moving if no motors were present in the crane assembly 10. When the motors kick in, they assist in the movement of the load “L” in direction in which the operator pushed or pulled the load, i.e., direction “C1” in FIG. 10. As the effort is increased by the operator, Θ increases slightly and the load “L” accelerates. When the operator lets off the load “L”, i.e., stops applying force thereto, Θ becomes “zero”, and the load “L” substantially immediately comes to a stop. It should be noted that when the load is Normal to the hoist assembly 26, a center of the load is at a height “H1” above the support surface “SS”. When the load is moved in the direction “D”, the center of the load moves further away from the support surface “SS”, increasing by the height “H2” when the hoist rope 28 is at the angle Θ.

When the operator “P” applies a force to the load “L” in the opposite direction, i.e., in the direction “C” (FIG. 10), the load moves in that same direction and the rope 28 becomes angled in an opposite direction to what is shown in FIG. 10, i.e., to a negative Θ value. Because of the application of force in this manner, the load “L” will move in the negative direction, i.e., in the direction “C”. Although not shown in this figure, the angle of the hoist rope 28 relative to Normal will increase until the hoist rope 28 is arranged at the angle Θ in the negative direction and the motors will kick in just before the point where the load would have started moving if no motors were present in the crane assembly 10. The application of force to the load by the operator “P” is what actuates the motors and therefore what actuates the movement assist system of crane assembly 10. As long as the operator “P” continues to apply force to the load “L”, the motors continue to assist in the movement of the load in the direction in which force is applied.

The pushing or pulling movement of the load is assisted through actuation of the various motors. In crane assembly 10, the movement of the load is a combination of the operator physically applying force to the load plus the assistance given by the various motors instead of the load being moved entirely through physical force applied by the operator or motorized movement entire due to the motors. The assisted movement offered by crane assembly 10 means that the operator “P” does not need to apply as much force to move load “L” from the first position “FP” to the second position “SP” as would be needed if the first end truck 20, second end truck 22 and trolley 24 had to be moved manually and entirely under the physical force applied by the operator. In crane assembly 10, the operator “P” maintains full hands-on control of the direction of movement of the load “L” at all times and further maintains full hands-on control over the speed of movement of the load at all times because the assisted movement is based on the pushing or pulling motion the operator exerts on the load. The activating and deactivating of the motors is substantially instantaneous because both functions are based on the initiation of a pushing motion or pulling motion of the operator “P” on the load “L” and the cessation of the pushing motion or pulling motion. Full hands-on control of the load's movement allows the operator “P” to more precisely place the load “L” where the operator wants the load to be. The assisted motorized movement provided by crane assembly 10 substantially reduces the force the operator needs to apply to effect movement of the load “L” while allowing the operator to retain full hands-on control and therefore precision locating of the load.

It will be understood that in some embodiments crane assembly 10 may further include one or more other sensors which can provide information about the position of load “L” in space to processor 30. The sensors may include optical sensors which may be provided at any appropriate location on crane assembly 10 or in the environment surrounding crane assembly 10. Information from the various sensors in the system, including any optical sensors, is communicated to processor 30.

While the presently disclosed assisted motorized system is described as being useful on an overhead bridge crane, it will be understood that the system could also be utilized with other overhead cranes including gantry cranes and monorail cranes. Monorail cranes only include a single runway beam and a motorized trolley which runs along the single runway beam. In such monorail crane assemblies the hoist assembly with hoist rope and engaged inclinometer/accelerometer will enable activation of the motor on the trolley upon a processor of the system receiving a signal from the inclinometer/accelerometer.

The device, assembly, or system of the present disclosure may additionally include one or more sensors to sense or gather data pertaining to the surrounding environment or operation of the device, assembly, or system. Some exemplary sensors capable of being electronically coupled with the device, assembly, or system of the present disclosure (either directly connected to the device, assembly, or system of the present disclosure or remotely connected thereto) may include but are not limited to: accelerometers sensing accelerations experienced during rotation, translation, velocity/speed, location traveled, audio sensors sensing local environmental sound levels, or voice detection; optical sensors, photo/light sensors sensing ambient light intensity, ambient, day/night, UV exposure; TV/IR sensors sensing light wavelength; temperature sensors sensing machine or motor temperature, ambient air temperature, and environmental temperature; and moisture sensors sensing surrounding moisture levels.

The device, assembly, or system of the present disclosure may include wireless communication logic coupled to sensors on the device, assembly, or system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the device, assembly, or system of the present disclosure may serve as a repeater, or the devices, assemblies, or systems of the present disclosure may be connected together in a mesh network to relay signals from one device, assembly, or system to the next. However, the individual device, assembly, or system in this scheme typically would not have IP addresses of their own. Instead, one or more of the devices, assemblies, or system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

In other embodiments, alerts and other data from the sensors on the device, assembly, or system of the present disclosure may also be sent to a work tracking system that allows the individual, or the organization for which he or she works, to track the status of the various alerts that are received, to schedule particular operators to repair a particular device, assembly, or system of the present disclosure, and to track the status of those repair jobs. A work tracking system would typically be a server, such as a Web server, which provides an interface individuals and organizations can use, typically through the communication network. In addition to its work tracking functions, the work tracker may allow broader data logging and analysis functions. For example, operational data may be calculated from the data collected by the sensors on the device, assembly, or system of the present disclosure, and the system may be able to provide aggregate machine operational data for a device, assembly, or system of the present disclosure or group of devices, assemblies, or systems of the present disclosure.

The system also allows individuals to access the device, assembly, or system of the present disclosure for configuration and diagnostic purposes. In that case, the individual processors or microcontrollers of the device, assembly, or system of the present disclosure may be configured to act as Web servers that use a protocol like hypertext transfer protocol (HTTP) to provide an online interface that can be used to configure the device, assembly, or system. In some embodiments, the systems may be used to configure several devices, assemblies, or systems of the present disclosure at once. For example, if several devices, assemblies, or systems are of the same model and are in similar locations in the same location, it may not be necessary to configure the devices, assemblies, or systems individually. Instead, an individual may provide configuration information, including baseline operational parameters, for several devices, assemblies, or systems at once.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. An overhead crane assembly for moving a load comprising:
at least one support beam;
a translation assembly moveable relative to the at least one support beam;
a hoist assembly operatively engaged with the translation assembly, wherein the hoist assembly is adapted to suspend a load therefrom; and
a movement assist system operably engaged with the translation assembly and the hoist assembly; and
wherein the movement assist system is operable to initiate movement of the translation assembly upon application of a physical force to the load by a human operator.

2. The overhead crane assembly according to claim 1, wherein the hoist assembly includes a hoist rope adapted to be engaged with the load; and wherein the movement assist system includes an inclinometer engaged with the hoist rope.

3. The overhead crane assembly according to claim 2, wherein the movement assist system further includes a processor provided with programming configured to control the movement of the translation assembly.

4. The overhead crane assembly according to claim 3, wherein the processor is configured to receive signals from the inclinometer.

5. The overhead crane assembly according to claim 4, wherein actuation of the translation assembly is initiated by the processor when a signal from the inclinometer indicates that the hoist rope is oriented at an angle relative to Normal.

6. The overhead crane assembly according to claim 1, wherein the at least one support beam comprises at one runway beam extending in a longitudinal direction; and wherein the translation assembly includes an end truck moveable longitudinally along the at least one runway beam, and the end truck is motorized.

7. The overhead crane assembly according to claim 6, wherein the at least one support beam further comprises a bridge oriented transverse to the at least one runway beam, and wherein the bridge is engaged with the end truck.

8. The overhead crane assembly according to claim 7, wherein the translation assembly further comprises a trolley movable along the bridge.

9. The overhead crane assembly according to claim 8, wherein the hoist assembly is operably engaged with the bridge via the trolley.

10. The overhead crane assembly according to claim 8, wherein the trolley includes a motor which is actuated to move the trolley along the bridge only after the human operator applies a pushing or pulling physical force to the load suspended from the hoist assembly.

11. A movement assist system for an overhead crane assembly comprising:
an inclinometer engaged with a hoist rope extending between a hoist assembly of the overhead crane assembly and a load to be moved;
a motor provided on a translation assembly of the overhead crane assembly;
a processor operably engaged with the inclinometer and the motor;
wherein the processor is configured to receive signals from the inclinometer; and
wherein the processor is configured to actuate the motor upon receipt of a first signal from the inclinometer indicating that the hoist rope is oriented at an angle relative to Normal.

12. The movement assist system according to claim 11, wherein the processor is configured to shut off the motor upon receipt of a second signal from the inclinometer indicating that the hoist rope is aligned with Normal.

13. A method of moving a load with an overhead crane assembly comprising:
operatively engaging a translation assembly with at least one support beam;
operatively engaging a hoist assembly with the translation assembly;
engaging a movement assist system with the hoist assembly;
suspending a load from the hoist assembly;
applying a physical force to the load via a hand of a human operator;
actuating the movement assist system upon application of the physical force;
actuating the translation assembly through actuating of the movement assist system; and
moving the load relative to the at least one support beam via the translation assembly.

14. The method according to claim 13, wherein applying the physical force to the load comprises one of pushing and pulling the load with the hand of the human operator.

15. The method according to claim 14, wherein actuating the movement assist system comprises moving a hoist rope of the hoist assembly from being aligned with Normal to being oriented at an angle to Normal.

16. The method according to claim 14, wherein actuating the translation assembly includes starting a motor provided on the translation assembly.

17. The method according to claim 14, wherein engaging the movement assist system comprises:
engaging an inclinometer with a hoist rope extending between the hoist assembly and the load; and
measuring an angle of the hoist rope relative to Normal with the inclinometer.

18. The method according to claim 14, further comprising deactivating the movement assist system by halting the application of physical force to the load with the hand of the human operator.

19. The method according to claim 18, further comprising halting movement of the translation assembly by shutting off a motor provided on the translation assembly when the application of physical force to the load is halted.
